(19) United States
(12) Patent Application Publication
(10) Pub. No.: US 2011/0227930 A1
(43) Pub. Date: Sep. 22, 2011

(54) FARMINIZER SOFTWARE

(76) Inventors: Ralph Huchtemann, Koln (DE); Andre Konnopatsch, Koln (DE)

(21) Appl. No.: 12/759,370

(22) Filed: Apr. 13, 2010

(30) Foreign Application Priority Data
Mar. 22, 2010 (EP) 10157251.9

(51) Int. Cl. G06F 9/445; G06F 9/44; G06T 13/00

(52) U.S. Cl. 345/473; 717/178; 717/173

(57) ABSTRACT

Method for the transfer of project data of a multidimensional animation from a first computer to a second computer which are connected via a network and has at least one rendering device (render farm), the required information of which is determined by a set of digital rules, comprising the following steps:
downloading a plug-in (farminizer plug-in) onto the first computer over the network and binding into an animation software package installed on a digital storage on the first computer,
collecting information related to the project data and/or the rendering device on the first computer through the plug-in by use of computing device;
checking the collected information based on a set of rules by use of a computing device, and if all the rules have been fulfilled, the collected information and the project data are transmitted over the network to the second computer; should the rules not be fulfilled, then a message is output on a display device or an adaptation of the project data is carried out fully automatically by a computing device and/or partially automatically with interactive guidance in order then to transmit the collected information and the project data over the network to the second computer;
automatic setting of the rendering device on the basis of the information and the project data and carrying out the rendering by the rendering device.

The invention relates to a method and a device for the controlled transmission and processing of data for rendering a multidimensional animation, on a server provided by a service provider.

### DESCRIPTION

It is known and conventional that project data of a 3D animation can be transferred to a service provider (render farm) for rendering. The term “to render” denotes the production of a graphic representation from a sketch or a model. This implementation involves a modelling of natural phenomena such as texture, refraction, reflection, shadow, etc., so that an impression of the materiality, the size and shape is imparted to the viewer.

This process is carried out in a form augmented by computer graphics with corresponding software. For this purpose, images for short film sequences or for complex graphics are often generated from 3D models.

The more complex the model is and the more images are required, the more computing power is necessary in order to render each model. This computing power is often bought in addition by a service provider as required, as the operator often does not have the necessary computing power and therefore pays to have its concluding project file processed by a render farm with a specially configured computing centre.

For this purpose, the operator stores its project data within its application, collects the additional secondary data (textures, maps, etc.) and uploads the data to the provider via a browser interface. In the browser, the operator finds options for starting the rendering process, for billing and for locally downloading the results of the rendering.

Problems of this include the fact that the above-described process is time-consuming and error-prone. On the one hand, the operator must manually carry out the entire preparation of the rendering; on the other hand, errors usually occur as a result of the different configuration of the local workstation and 3D application of the operator and also the configuration of the computers of the render farm. The basic configuration of a 3D application contains parameters which are not secured in a file-immanent manner by simple storing of the project file. Additional and conventional modifications of the 3D application by the operator by means of further plug-ins, rendering engines, version numbers, etc. are not stored either.

### OVERVIEW OF THE INVENTION

These and further problems described hereinafter are solved by the features recited in the patent claim.

Specifically, it is a method for the transfer of project data of a multidimensional animation (preferably 3D animation) from a first computer to a second computer which is connected via a network and has at least one rendering device. In the preferred embodiment, the render farm consists of a large number of computers which are centrally controlled and which are accessible via the Internet. The information required by the render farm is determined by a set of rules.

The method comprises the following steps. After a user has entered the website of the provider of the render farm, he can download a plug-in (Farminizer plug-in) and bind it on his computer (first computer) into the animation software installed on the computer. The plug-in software collects information related to the project data and/or the rendering device on the first computer. The collected information is checked based on a set of rules, such as will be described hereinafter. If all the rules have been fulfilled, the collected information and the project data are transmitted directly or indirectly to the render farm; should the rules not be fulfilled, a message is output or an adaptation of the project data is carried out fully automatically and/or partially automatically with interactive guidance in order then to transmit the collected information and the project data to the second computer. After the render farm has acquired these data, the rendering device is automatically set on the basis of the information and the project data and the rendering is carried out.

Additional parts of the invention are devices which enables the method.

The advantages achieved by the invention consist in particular in that the cancellation of incompatibilities is enforced within the 3D application; that is to say, wherever an adaptation and automatic modification of the project is in any way possible.

The collecting of project-specific, but not project file-immanent data additionally adapts the render farm to the project.

The process starts within the 3D application which the operator must for this reason not leave.

In the background, the software downloads the results of the computation and stores them locally at the location specified in the project file. The operator accordingly experiences increased convenience as a result of the automation.

The entire process for the remote-controlled computation of a 3D animation on a render farm (uploading, downloading and locally filing at a desired location) is triggered by a single click. The process is comparable to a local rendering on the operator's computer.

The complexity of these applications produces numerous sources of error which make a computation impossible or lead to erroneous results. Furthermore, the quantity of files required is often vast, as the files are usually located at different locations on the operator PC and also are often distributed in the operator's local network.

### Mode of Operation of the Farminizer Software

The operator (referred to hereinafter as A) obtains from the service provider (referred to hereinafter as B) a software package consisting of the “manager” and the “Farminizer” plug-in for all 3D applications. The manager functions in this regard as the central collecting point and means for managing all the local projects of A and serves to provide an overview of the current state of progress of projects which have already been transmitted, to install the Farminizer plug-in and also to transmit the project data to the render farm and to receive the computed files.

The purpose of the Farminizer plug-in is to ensure in the respective 3D application that the respective previously created project of A meets the framework conditions on the render farm and can be computed correctly and completely. For this purpose, a number of technical tests are carried out and finally unitary “packages” are created and exported that can be automatically imported in the manager and processed homogeneously by the render farm. After the data have been successfully transferred to the manager, the original state of the data is reestablished, so that A does not find any change.

### Detailed Sequence of the Plug-In Software

During the installation of the plug-in, menu entries are automatically integrated in the 3D application, allowing the Farminizer to be started as in a normal rendering process. Subsequently, various tests are carried out which check the project for possible problems in relation to the computation on the render farm. These tests may be broken down roughly into five sub-areas:

General Checks

These contain analyses with respect to the operator system used and also to establish whether general demands placed on a scene, which are required for computation, are met:
Is the individual plug-in version compatible with the manager or up to date?
Are sufficient rights of the logged-in user present?
Are required file accesses possible?
Does the scene contain dynamic links to other scenes (for example XRefs)?
Does the scene contain at least one light source?
Does the scene contain animated textures?

The results of these analyses are logged and displayed to the user (similar to an error message). Preferably, it is possible to proceed only when the above-mentioned checks are successful. It is often down to the user to eliminate the errors, as the plug-in software is of course not able to obtain administrator rights, etc. throughout the system.

In addition, “meta-information” about the scene is collected which can be interpreted by the render farm accordingly. The meta-information is written into a configuration file automatically, without user interaction, and transmitted to the manager. The meta-data contain inter alia:
the version and extensions (for example service packs) of the 3D application and also of the renderer used
the units and dimensioning of the 3D application
the underlying platform (Windows, Mac, 32-bit or 64-bit architecture) and the version
the units context (for example decimal point or decimal comma?)
the cameras used

Checking the Render Settings

These include general checks with respect to the render settings, which are independent of specific rendering engines:
Is the resolution to be rendered outside the given limits?
Which gamma values of the 3D application are provided?
Which frames are to be rendered? Are there segments or jumps?
Are pre-render scripts executed?
Are post-render effects used?
Have frame buffers been defined, which settings do these have and is at least one activated for the rendering?
Are there invalid camera settings (such as for example “tiled”)?
Is a non-supported renderer activated?
In which format is the result to be output, what is it to be named and are these particulars valid or are they supported by the rendering system?

In this case too, invalid test results are displayed to the user, so that he can correct the corresponding parameters in the scene.

A special case is the check to establish whether an individual image or an animation is to be rendered. This is carried out automatically based on the number of frames set by the user. If the number of frames comprises just one frame, then a user query is generated as to whether this one frame is to be rendered in distributed form on the render farm (distributed single frame job). If the answer to this is “yes”, then further, single-frames specific checks are carried out: the resolution should exceed 400×400 pixels and, in addition, be divisible by a factor of 10 without remainder. Subsequently, the plug-in logs in the configuration file whether a single-frame job is to be rendered.

Checking Textures/Maps

An important part of the plug-in is the collecting of all the external textures and other files which are dependent on the operator project, so that these are present when computing on the render farm:
Find all the textures used
Determine all the other dependencies on external files; these comprise inter alia VRay files, mental ray files, global illumination files, photon maps, irradiance maps, final gather maps, IF1 files, point caches, simulation caches, particle caches, hair caches, etc.
Are all these dependent files present and readable at the moment of export? If not, are all the problematic file references displayed to the user, so that he can either remove the reference to the file in the scene or else provide the file at an appropriate location? An export is possible only when all the references are present in error-free form.
Do all the file names comply with the requirements of the farm? (That is to say, in particular, contain no special characters and gaps). If this is not the case, are all the invalid files automatically renamed and newly linked in accordance with an individual notation? The correction is automated—i.e. does not involve any user interaction.
Has the operator already loaded one or more of the files used with one or other project onto the render farm? This check is carried out “live” in the plug-in; a signal is sent to the manager which provides a list of the user files currently present on the FTP server of the render farm. The list is then matched with the files used of the scene in the plug-in. If identical files are present, only the reference to this file (corresponding to a link) is noted, although the file itself is not copied. In this way, an operator can keep a “file pool” on the farm and files which are already present do not have to be uploaded again. The md5 checksum method is in this case used for file matching in order to ensure complete identity.

Checks of Specific Renderers

Each rendering engine contains specific settings and parameters which must accordingly be analysed separately. Current examples of Farminizer-supported renderers (non-proprietary renderers of the 3D application) are mental ray, Vray, final render, Maxwell. The checks relate inter alia to the version of the renderer, add-ons used, global illumination modes, sampling, gamma correction, etc.

Checking of Dependencies on Plug-Ins or User-Defined Shaders

3D applications are often extended by the operator using external add-ons (for example plug-ins or custom shaders). If these relate to the rendering process or the result in the computation, then a corrected result is provided only when the render farm has the same plug-ins or the same versions of these. For each 3D application and each platform and version of these, a whitelist, i.e. a listing of all the installed extensions, is located on the render farm server. The Farminizer plug-in is automatically connected to the server and checks whether there is a new version of this whitelist. If this is the case, the local data stock is automatically updated. Checks include:
Are local extensions installed in the operator which are not present on the render farm?
Does the scene use non-proprietary plug-ins or shaders?
Are materials which utilise non-proprietary shaders used in the scene?

If all the checks have been successfully passed, the project can be directly exported. If this is not the case, then a report which provides information about critical situations and creates appropriate indications in the event of implausible inputs is displayed to the user. Such indications contain brief instructions as to how to deal with the errors. The Farminizer can remain opened in this case; the operator can make live changes to the project and subsequently restart the check as many times as desired.

Export:

The export routine packages the operator project into a homogeneous structure which the manager and render farm can read and automatically sets scene or renderer parameters necessary for the render farm. A project can be exported only if all the checks have been passed without error—user errors and incompatible projects are thus detected even before the route to the render farm and can be corrected directly on site in the 3D application.

Prior to export, all the required files are automatically copied into a specific individual folder structure locally in the operator and newly linked accordingly in the project. Thus, after export, there are no dependencies of external files outside the Farminizer's own directory, thus preventing the absence of resources required at the moment of transition to the render farm. Likewise, previously used absolute path specifications of A, which are of course not present on the render farm, are in this way removed and adapted accordingly to the conditions on the server.

The Farminizer plug-in creates a config file containing meta-data concerning the project. This logs all the project information, such as for example which frames are to be rendered, in which 3D application the project was created, which rendering engine is to be used. The listing of all the external dependencies, such as textures or other files including the checksum thereof, is very important in this regard. It is thus possible to detect upload errors and incomplete projects even before demands have been made on the render farm's computing effort.

Subsequently, the total package, consisting of the project files, the config file and all the external textures and other files, are written to the manager for further processing. The package itself is encrypted, so that it is no longer possible to change the exported project. The manager receives a message and then starts or updates and imports the new project package on a stand-alone basis.

The final task of the Farminizer plug-in is to reestablish the starting state of the operator project. This is necessary to enable the scene to render locally in an error-free manner on the operator PC itself and to prevent farm-specific changes from being persistently stored. Depending on the 3D application, this takes place either by reversing changes which have been made or by discarding the modified scene and reloading the original file.

### DESCRIPTION OF THE FIGURES

The figures will be described hereinafter. In the drawings:

FIG. 1 shows a schematic construction of the invention with a first computer and the render farm;

FIG. 2 shows a sequence of steps which the system according to the claims carries out.

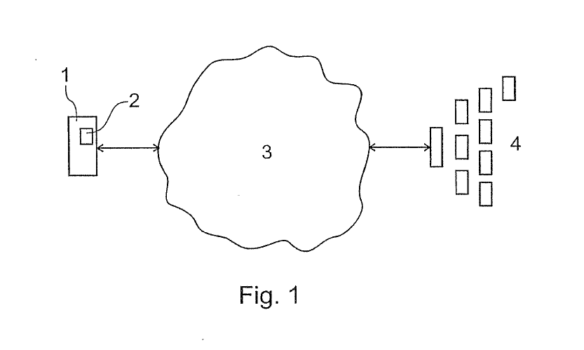

FIG. 1 shows the basic construction of the system. The plug-in 2 is installed on a first computer 1. The network 3 (Internet) provides a connection to the render farm 4.

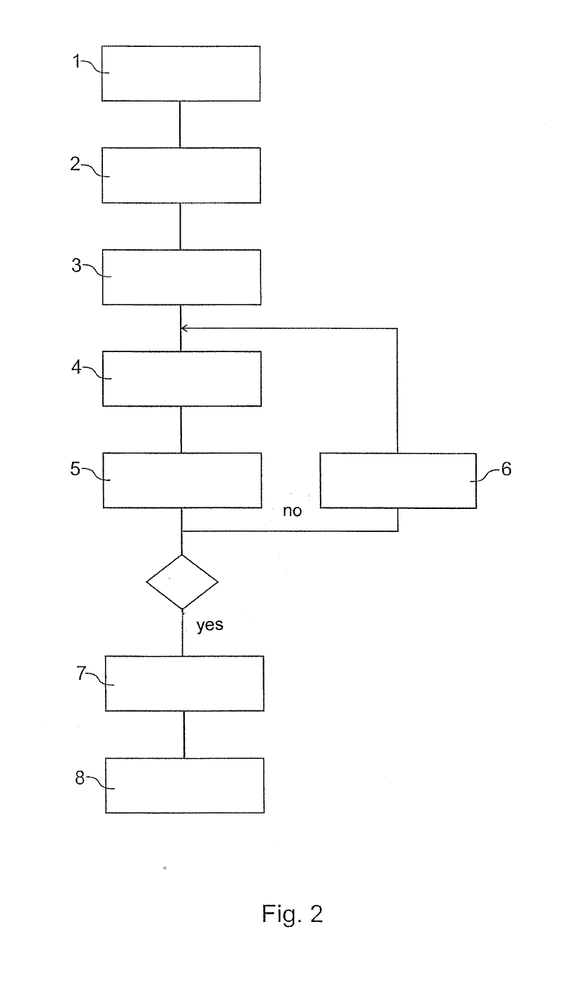

FIG. 2 shows the schematic sequence of the method. The plug-in is downloaded in a step 1. The plug-in 2 is then installed. In step 3, the plug-in is called by the application. The plug-in collects information in step 4, The information collected in this way is checked in step 5 by the plug-in, compared to the set of rules and if appropriate adapted where possible.

If not all the rules are fulfilled, an indication 6 is provided to the user who can then modify the data in order to carry out the check again.

In step 7, the plug-in transmits the information and the project data via a network connected to the second computer which has at least one rendering device (render farm), the required information of which is determined by the set of rules. The rendering device is then automatically set on the basis of the information and the project data, and the rendering is finally carried out in step 8.

The disclosed embodiments are only examples which do not intend to limit the scope of protection. It is intended to obtain a broad scope of protection defined by the enclosed set of claims.

1. Method for the transfer of project data of a multidimensional animation from a first computer to a second computer which are connected via a network and has at least one rendering device (render farm), the required information of which is determined by a set of digital rules, comprising the following steps:
downloading a plug-in (farminizer plug-in) onto the first computer over the network and binding into an animation software package installed on a digital storage on the first computer,
collecting information related to the project data and/or the rendering device on the first computer through the plug-in by use of computing device;
checking the collected information based on a set of rules by use of a computing device, and if all the rules have been fulfilled, the collected information and the project data are transmitted over the network to the second computer; should the rules not be fulfilled, then a message is output on a display device or an adaptation of the project data is carried out fully automatically by a computing device and/or partially automatically with interactive guidance in order then to transmit the collected information and the project data over the network to the second computer;
automatic setting of the rendering device on the basis of the information and the project data and carrying out the rendering by the rendering device.

2. The method according to claim 1, wherein the plug-in is bound into 3D applications such as Autodesk Maya, Autodesk 3D Studio MAX, Maxon CINEMA 4D, Autodesk Softimage, Newtek Lightwave, Blender Foundation Blender, Luxology Modo, Autodesk Revit, Rhinoceros 3D, Planetside Terragen, Nextlimit Maxwell, Eon Vue, Autodesk Mudbox, Pixologic Z-brush, Smith Micro Poser, Abvent Artlantis.

3. The method according to claim 1, wherein a computing device checks during start-up of the plug-in that the set of rules is up to date and, and if a newer set of rules is present, downloading the new set of rules over the network.

4. The method according to claim 1, wherein a configuration of the rendering device is performed automatically based on the project data and collected information.

5. The method according to claim 1, wherein incompatibilities between the animation software and the rendering device are detected or eliminated based on the set of rules using a computing device by altering both the project file prior to rendering and the configuration of the rendering device.

6. The method according to claim 1, wherein the rendering of the project data by the rendering device is carried out without further input on the part of the operator and with preferably just one click and the results of the rendering are automatically stored on the first computer on a storage device and/or wherein the original state of the data is reestablished once the data have been successfully transferred, so there are no changes on the first computer, this being carried out preferably by reversing changes which have been made or by discarding the modified data and reloading the original data.

7. The method according to the preceding claim 1, wherein menu entries are automatically integrated in the animation application when the plug-in is installed, thus allowing remote rendering to be started in a manner similar to a normal rendering process.

8. The method according to claim 1, wherein a general check is carried out in which one or more of the following criteria is checked:
Are sufficient access rights of the logged-in user present on the first computer?
Are required file accesses present on the computer?
Does the scene contain dynamic links to other scenes?
Does the scene contain at least one light source?
Does the scene contain animated textures?

9. The method according to claim 1, wherein meta-information about the project data is collected which can be interpreted by the rendering system accordingly, the meta-information being one or more of the following:
a version and/or extensions of the animation software and also of the renderer used and the gamma values thereof,
an underlying operating system platform of the first computer,
the units, dimensioning and the context thereof,
the cameras used.

10. The method according to claim 1, wherein the render settings are checked, with one or more of the following criteria:
Is the resolution to be rendered outside given limits?
Which frames are to be rendered?
Are there segments or jumps?
Are pre-render scripts executed?
Are post-render effects used?
Have frame buffers been defined and/or which settings do these have and is at least one activated for the rendering?
Are there invalid camera settings?
Is a non-supported renderer activated?
In which format is the result to be output, what is it to be named and are these supported by the rendering system?

11. The method according to claim 1, wherein a check is carried out to establish whether an individual image or an animation is to be rendered, this being carried out automatically based on the frame number set by the user and wherein means are present that generate, in the case of just one frame, a user query which asks the user whether this one frame is to be rendered in distributed form on the rendering system.

12. The method according to claim 1, wherein means are present that determine other dependencies on external files and data in order to check whether these files are present and readable at the moment of export, wherein means are present by way of which the files preferably comprise one or more of the following files: VRay files, mental ray files, global illumination files, photon maps, irradiance maps, final gather maps, IF1 files, point caches, simulation caches, particle caches, hair caches, etc. and/or wherein means are present which check the file name and the file content for compatibility and if necessary automatically make changes to the file name and/or the link and/or the contents.

13. The method according to claim 12, wherein means are present which check whether the operator has already transmitted in advance one of the files in conjunction with other project data; if this is the case, a reference is merely generated, and the data are not retransmitted.

14. The method according to claim 12, wherein means are present that check whether the animation software contains a dependency on plug-ins or user-defined shaders in order to check whether these are admissible based on the set of rules.

15. Computer, for providing project data of an animation software package, comprising:
a loading apparatus, embodied and configured to download a plug-in (Farminizer plug-in) and to bind this into the animation software installed on the first computer; the plug-in is embodied and configured to collect information which is related to the project data and/or the rendering device;
an computing device embodied and configured for evaluating the collected information based on a set of rules, and if all the rules have been fulfilled, the collected information and the product data are prepared for dispatch; should the rules not be fulfilled, then a message is output on a display device or an adaptation of the project data is carried out fully automatically and/or partially automatically with interactive guidance by the computing device in order then to prepare the collected information and the project data for dispatch;
a transmission device which transmits the collected project data and the information.

16. Computer according to claim 15, wherein the computing device checks during start-up of the plug-in that the set of rules is up to date and, and if a newer set of rules is present, downloading the new set of rules over the network.

17. Computer according to claim 15, wherein the computing device detects or eliminates incompatibilities between the animation software and the rendering device based on the set of rules by altering both the project file prior to rendering and the configuration of the rendering device.

18. Computer according to claim 15, wherein the computing device automatically integrates menu entries in the animation application when the plug-in is installed, thus allowing remote rendering to be started in a manner similar to a normal rendering process.

19. Computer according to claim 15, wherein the computing device carries out a general check in which one or more of the following criteria is checked:
Are sufficient access rights of the logged-in user present on the first computer?
Are required file accesses present on the computer?
Does the scene contain dynamic links to other scenes?
Does the scene contain at least one light source?
Does the scene contain animated textures?

20. The computer according to claim 15, wherein the computing device collects meta-information about the project data which can be interpreted by the rendering system accordingly, the meta-information being one or more of the following:
a version and/or extensions of the animation software and also of the renderer used and the gamma values thereof,
an underlying operating system platform of the first computer,
the units, dimensioning and the context thereof,
the cameras used.

21. The computer according to claim 15, wherein computing device checks the render settings, with one or more of the following criteria:
Is the resolution to be rendered outside given limits?
Which frames are to be rendered?
Are there segments or jumps?
Are pre-render scripts executed?
Are post-render effects used?
Have frame buffers been defined and/or which settings do these have and is at least one activated for the rendering?
Are there invalid camera settings?
Is a non-supported renderer activated?
In which format is the result to be output, what is it to be named and are these supported by the rendering system?

22. The computer according to claim 15, wherein the computing device carries out a check to establish whether an individual image or an animation is to be rendered, this being carried out automatically based on the frame number set by the user and wherein means are present that generate, in the case of just one frame, a user query which asks the user whether this one frame is to be rendered in distributed form on the rendering system.

23. The computer according to claim 15, wherein the computing device determines dependencies on external files and data in order to check whether these files are present and readable at the moment of export, wherein the data are textures, VRay files, mental ray files, global illumination files, photon maps, irradiance maps, final gather maps, IF1 files, point caches, simulation caches, particle caches, hair caches, or wherein means are present which check the file name and the file content for compatibility and if necessary automatically make changes to the file name and/or the link and/or the contents.

24. Computer for rendering the project data of an animation software package, comprising:
a unit for providing a plug-in with a set of rules;
a reception unit which receives project data and the additionally collected information which has been produced by the plug-in;
a rendering system which is to be parameterised on the basis of the project data and the collected information, and which renders the project data.

25. The computer according to claim 24, wherein a configuration of the rendering device is performed automatically based on the project data and collected information.

26. The computer according to claim 24
wherein the rendering of the project data by the rendering device is carried out without further input on the part of the operator and with preferably just one click and the results of the rendering are automatically stored on a storage device and wherein the original state of the data is reestablished once the data have been successfully transferred, so there are no changes on the first computer, this being carried out preferably by reversing changes which have been made or by discarding the modified data and reloading the original data.
